(19) United States
(12) Patent Application Publication
(10) Pub. No.: US 2026/0036668 A1
(43) Pub. Date: Feb. 5, 2026

(54) REAL-TIME INTERFERENCE MITIGATION METHOD FOR AUTOMOTIVE RADAR

(71) Applicant: VIRGINIA TECH INTELLECTUAL PROPERTIES, INC., Blacksburg, VA (US)

(72) Inventors: Yubo Wu, Blacksburg, VA (US); Y. Thomas Hou, Blacksburg, VA (US)

(21) Appl. No.: 19/137,439

(22) PCT Filed: Sep. 5, 2023
(86) PCT No.: PCT/US2023/073467

§ 371 Date: Jun. 10, 2025

Related U.S. Application Data
(60) Provisional application No. 63/387,614, filed on Dec. 15, 2022.

(30) Foreign Application Priority Data
Dec. 15, 2022 (AU) 2022903854

(51) Int. Cl. G01S 7/02; G01S 7/35; G01S 13/931

(52) U.S. Cl. CPC G01S 7/023; G01S 7/356; G01S 13/931

(57) ABSTRACT

Real-time vehicle radar interference mitigation concepts are described. In one embodiment, a method to mitigate interference for a vehicle radar includes detecting a target object in a vicinity of a vehicle. The detection of the target object generates an intended signal. The method further includes detecting an interference signal in the vicinity of the vehicle and receiving a return signal that includes the intended signal and the interference signal. The method further includes transforming the return signal to a frequency-time domain return signal using a short-time Fourier transform, determining a reconstructed interference signal in a frequency-time domain, transforming the reconstructed interference signal to a time domain, and removing the interference signal in the time domain from the return signal to isolate the intended signal based on the reconstructed interference signal in the time domain. The method further includes employing a parallel and computational efficient structure to deliver real-time output.

### CROSS-REFERENCE TO RELATED APPLICATION

This application claims the benefit of and priority to U.S. Provisional Patent Application No. 63/387,614, titled “REAL-TIME INTERFERENCE MITIGATION METHOD FOR AUTOMOTIVE RADAR,” filed Dec. 15, 2022, the entire contents of which is hereby incorporated by reference herein.

### STATEMENT REGARDING FEDERALLY SPONSORED RESEARCH OR DEVELOPMENT

This invention was made with government support under grant number CNS-1837519, awarded by the National Science Foundation (NSF). The government has certain rights in the invention.

### BACKGROUND

Automotive radar is an important component of advanced driver assistant systems (ADASs) and a key sensing technology for target detection. Automotive radar can be used to support adaptive cruise control, blind spot detection, and intelligent park assist, among other driver assist tools. Automotive radar exploits the difference between transmitted and received continuous electromagnetic waves to obtain the range, velocity, and angle for a target. Compared to Lidar and camera, radar has the advantage of being able to work at nighttime and is not affected by bad weather such as fog and snow.

### SUMMARY

The present disclosure is directed to a radar interference mitigation system and methods for implementing the same that can be used to mitigate interference in vehicle radar systems such as, for instance, automotive radar systems. In particular, described herein is a real-time compressed sensing-based interference mitigation framework (“interference mitigation framework”) for a Frequency Modulated Continuous Wave (FMCW) radar system. The interference mitigation framework exploits the sparsity of an interference signal in a frequency-time domain to separate an intended signal from the interference signal. The interference mitigation framework can achieve high-performance interference mitigation in real-time by leveraging parallel computation of a graphics processing unit (GPU) in some cases.

Aspects and advantages of embodiments of the present disclosure will be set forth in part in the following description or can be learned from the description or through practice of the embodiments. Other aspects and advantages of embodiments of the present disclosure will become better understood with reference to the appended claims and the accompanying drawings, all of which are incorporated in and constitute a part of this specification. The drawings illustrate example embodiments of the present disclosure and, together with the description, serve to explain the related concepts of the present disclosure.

According to one example embodiment, an interference mitigation system for a vehicle radar that is coupled to a computing device is described. In this example, the computing device is configured to receive a return signal using the vehicle radar, the return signal including an intended signal and an interference signal. The computing device is further configured to transform the return signal to a frequency-time domain return signal using a short-time Fourier transform. The computing device is also configured to determine a reconstructed interference signal in the frequency-time domain based on the frequency-time domain return signal, the reconstructed interference signal being an estimation of the interference signal. The computing device is further configured to transform the reconstructed interference signal to a time domain version of the reconstructed interference signal. The computing device is also configured to remove the interference signal in the time domain from the return signal to isolate the intended signal in the time domain based on the time domain version of the reconstructed interference signal.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the concepts of the disclosure. Moreover, repeated use of reference characters or numerals in the figures is intended to represent the same or analogous features, elements, or operations across different figures. Repeated description of such repeated reference characters or numerals is omitted for brevity.

FIG. 1 illustrates an example networked environment for interference mitigation of automotive radar according to various examples described herein.

FIG. 2 illustrates a flowchart illustrating an example method to mitigate interference for automotive radar according to various examples described herein.

FIG. 3 illustrates a flowchart illustrating another example method to mitigate interference for automotive radar using a graphics processing unit (GPU) according to various examples described herein.

### DETAILED DESCRIPTION

Automotive radar is a key component of advanced driver assistant systems (ADASs). As more vehicles are equipped with automotive radars, interference among the radars can become a problem and degrade the performance of target detection. Interference mitigation algorithms should be designed to minimize the impact of interference under highly dynamic driving conditions while meeting stringent requirements on processing time. Based on a recent study from the National Highway Traffic Safety Administration (NHTSA), in current Frequency Modulated Continuous Wave (FMCW) radar systems (i.e., operating in the 76-81 gigahertz (GHz) range), interference level on the highway can reach four orders of magnitude, or nearly 40 decibels (dB), higher than echoes of a reference target. If not removed, such interference can seriously degrade target detection performance and bring concerns about automotive safety, especially for an autonomous vehicle.

Among interference mitigation algorithms, compressed sensing (CS)-based algorithms have shown strength in recent years. Compared to other approaches, CS-based algorithms have a simpler structure and can be easily implemented at the radar receiver. Such algorithms are also compatible with conventional FMCW radar systems and thus can be readily deployed on the road. An exemplary mitigation algorithm includes an iterative method with adaptive thresholding (IMAT) algorithm. This method first removes both the interference signal and a portion of the intended signal and then tries to recover the intended signal. By totally removing the samples during interference duration, IMAT's performance is not affected by the interference power. But, when the interference duration increases (i.e., the number of missing samples increases), its performance severely deteriorates. Also, since IMAT is based on an iterative method, its complexity is high.

Another exemplary mitigation algorithm includes a morphological component analysis approach (MCA). The MCA approach explores the sparsity of intended and interference signals in different domains. Although it utilizes more than one domain to separate the intended signal and the interference signal, the complexity of the MCA approach increases dramatically compared with algorithms based on one domain. Another exemplary mitigation algorithm includes a greedy matching pursuit method. This method can be processed in 70 milliseconds (ms) in one-interferer case, which is prohibitively large for an automotive radar system. Another exemplary mitigation algorithm includes an algorithm based on Bayesian learning that explores the sparsity of the intended signal in a range-Doppler spectrum. Since this method uses all samples to reconstruct the intended signal, its performance is not affected by the interference duration. But when the interference power increases, the spectrum of interference in the range-Doppler spectrum can drown out the intended signal, which can significantly degrade the performance.

Although existing CS-based interference mitigation algorithms outlined above can mitigate mutual radar interference to some extent, none of them can achieve high performance under high interference conditions (i.e., both high interference power and long interference duration) in real-time. Examples of “real-time” applications are those that suggest a time from receiving signals at the radar to completing interference mitigation on the vehicle of approximately 10 ms, so as to be compatible with rapidly changing driving dynamics.

To address the challenges outlined above, a real-time compressed sensing-based interference mitigation algorithm for a Frequency Modulated Continuous Wave (FMCW) radar system is presented and described herein. In one example, a method to mitigate interference for an automotive radar includes detecting a target object in a vicinity of an automobile equipped with the automotive radar, where the detection of the target object generates an intended signal. The method further includes detecting an interference signal in the vicinity of the automobile and receiving a return signal that includes a combination of the intended signal and the interference signal. The method further includes transforming the return signal to the frequency-time domain using a short-time Fourier transform. For instance, the method further includes transforming the return signal to a hybrid frequency-time domain return signal using a short-time Fourier transform in one example. The method further includes determining a reconstructed interference signal in the frequency-time domain, transforming the reconstructed interference signal to the time domain, and removing the interference signal in the time domain from the return signal based on the reconstructed interference signal, to isolate the intended signal in the time domain.

Unlike most CS-based algorithms that explore the sparsity of intended signals in the frequency domain to reconstruct the intended signal, the embodiments of the present disclosure, which can include a graphics processing unit (GPU)-implemented algorithm titled “Soteria” in some examples, explore the sparsity of interference signals in the frequency-time domain to reconstruct the interference signal. By exploring the sparsity of the interference signals in the frequency-time domain, even under high-level interference scenarios (e.g., high interference power and long interference duration), the interference signal can be accurately reconstructed and removed. To reconstruct the interference signal, aspects of the embodiments employ a Compressive Sampling Matching Pursuit (CoSaMP) algorithm, which offers a good balance between complexity and reconstruction accuracy. In some examples of the CoSaMP algorithm, the measurement matrix is formed by a signal basis that includes all possible interference components. This allows the interference signal to be reconstructed as a linear combination of the least number of possible interference components.

In some examples, the method to mitigate interference for automotive radar referenced above can be implemented in a GPU, with a parallel structure to reduce computation time and meet the real-time requirement discussed above. In addition, aspects of the embodiments reduce the size of the search space (i.e., signal basis) in CoSaMP to accelerate the signal reconstruction process. Specifically, the size of the search space is narrowed by estimating the interference duration and exploiting the intrinsic correlation between the interference signals in consecutive time slots. In one example, the method to mitigate automotive radar can be implemented on an Nvidia V100 GPU. Simulation results show that this implementation outperforms the state-of-the-art CS-based algorithms (i.e., Zeroing and IMAT) in terms of target detection. Further, this implementation can achieve approximately 10 ms computation time for up to 3 interferers in some cases.

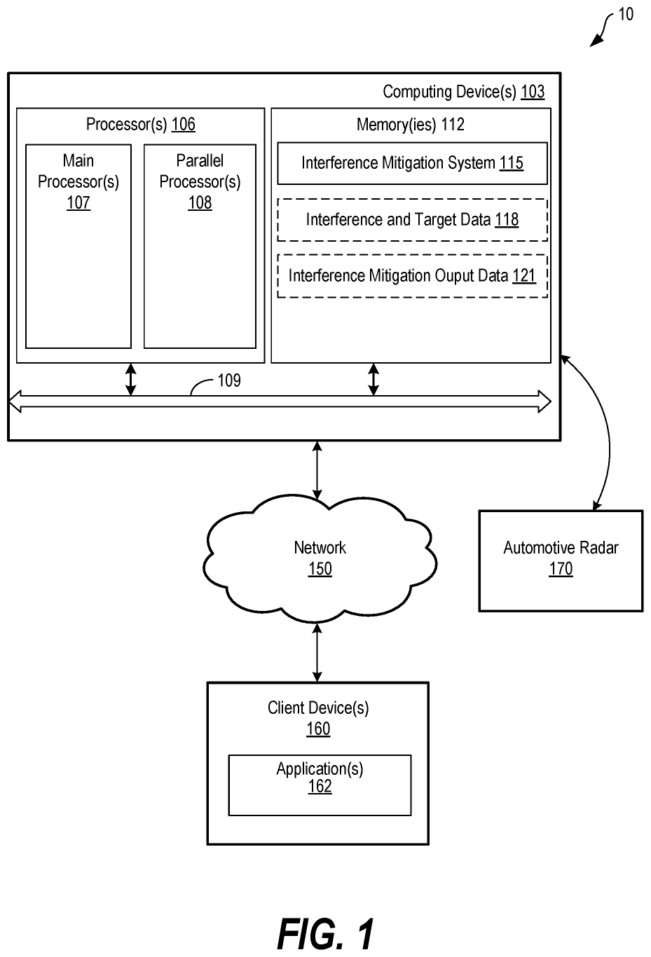

Turning to the drawings, FIG. 1 illustrates an example networked environment 10 for implementation of an interference mitigation system 115 for automotive radar according to various examples described herein. Although the example embodiments described herein and illustrated in the figures involve the implementation of the interference mitigation system 115 with automotive radar, the present disclosure is not so limited. For instance, the interference mitigation system 115 can be implemented with other types of vehicle and vehicle radar systems used in dynamic applications such as, for example, marine and watercraft radar, aviation and aircraft radar, and other types of radar systems.

The networked environment 10 includes a computing device 103, a network 150, a client device 160, and an automotive radar 170 (“radar 170”). Aspects of the interference mitigation system 115 are described below with reference to the radar 170, the computing device 103, and the client device 160, but these components are representative and other networked environments and components can be relied upon to implement the concepts described herein. In some cases, the networked environment 10 can include other components not shown in FIG. 1, as described below. Additionally, one or more of the components shown in FIG. 1 can be omitted in some cases.

The computing device 103 includes one or more processors 106 (collectively, “processor 106”), at least one memory 112 (collectively, “memory 112”), a local interface 109, and possibly other components. The processor 106 and the memory 112 are coupled to the local interface 109 for data communication between them. The local interface 109 may include, for example, a data bus with an accompanying address/control bus or other bus structure as can be appreciated. The local interface 109 can be embodied as one or more parallel interfaces, serial interfaces (e.g., PCI-E interfaces, etc.), or related local interfaces.

The processor 106 includes a main processor 107 (e.g., one or more central processing units (CPUs)) and a parallel processor 108 (e.g., one or more graphics processing units (GPUs), field programmable gate arrays (FPGAs), application specific integrated circuits (ASICs), etc.), among possibly other processing circuitry. The parallel processor 108 can include a number of parallel processors in some cases. In one example, the parallel processors 108 can be collectively embodied and implemented as a number of GPUs. The processor 106 can execute software or computer-readable instructions stored on the memory 112 in some cases.

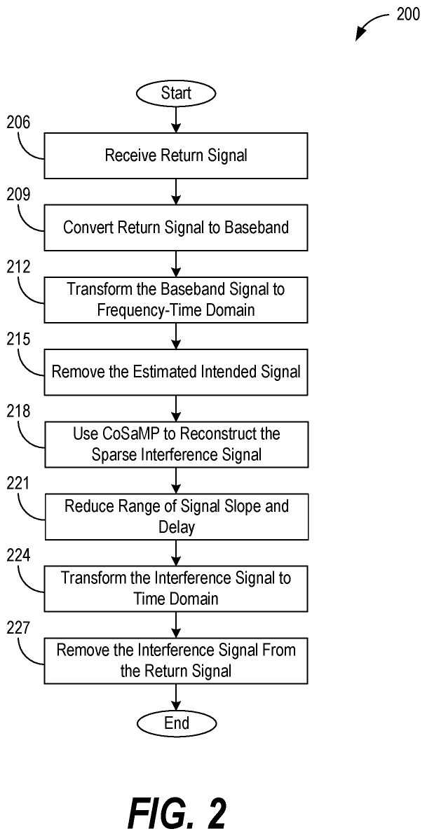

Stored in the memory 112 are both data and several components that are executable by the processor 106. In particular, stored in the memory 112 and executable by the processor 106 are the interference mitigation system 115 and potentially other applications. The interference mitigation system 115 can include executable computer-readable instructions for a method to mitigate interference for various types of vehicle radar such as, for instance, automotive radar (e.g., the radar 170). In one example, the interference mitigation system 115 can include executable computer-readable instructions for the method 200 described below and illustrated in FIG. 2. In some examples, the interference mitigation system 115 can implement (e.g., via the processor 106, the main processor 107, and the parallel processors 108) the method 200 to mitigate interference for various types of vehicle radar such as, for instance, automotive radar (e.g., the radar 170).

Also stored in the memory 112 is interference and target data 118 (or “data 118”), which can include data gathered by the radar 170. For example, the data 118 gathered by the radar 170 can include data related to detected targets and detected interference signals in the vicinity of a vehicle such as, for instance, an automobile equipped with the radar 170. In one case, the data 118 gathered can include a return signal that includes a combination of an intended signal and an interference signal. In this example, the intended signal can be based on (e.g., representative of) one or more detected targets and the interference signal can be based on (e.g., representative of) one or more detected interference signals generated from at least one other radar such as, for instance, another automotive radar of another automobile.

The interference mitigation system 115 can perform various computational operations and implement various algorithms with the gathered interference mitigation data 118 to mitigate the detected interference signals, thereby generating interference mitigation output data 121 (or “output data 121”). In one example, the interference mitigation system 115 can, among other actions, reconstruct the detected interference signal in a frequency-time domain, transform such a reconstruction of the detected interference signal to a time domain, and remove the detected interference signal from the return signal in the time domain to isolate the intended signal, thereby mitigating interference and generating the output data 121.

The computing device 103 and the radar 170 may be positioned at different locations on a vehicle or automobile. For example, the computing device 103 can be located as part of the vehicle computer system of an automobile or as part of an independent vehicle computer system, while the radar 170 (or sensors for the radar) can be positioned in, on, or behind the bumper, the headlight cover, the driver and passenger side mirrors, and at other locations of the automobile. The radar 170 can be directly coupled to the local interface 109 of the computing device 103. In other cases, the radar 170 can be coupled to the computing device 103 through the network 150. The connection between the radar 170 and the computing device 103 can include I²C, Ethernet, Controller Area Network (CAN), Media Oriented Systems Transport (MOST), Local Interconnect Network (LIN), Flexray® Automotive Communication, and other network communication interfaces and protocols and combinations thereof.

The network 150 can include a vehicle bus system, such as I²C, Ethernet, CAN, Flexray®, LIN, and other network communication interfaces and protocols and combinations thereof. In some cases, the network 150 can also include or be communicatively coupled to the Internet, intranets, extranets, wide area networks (WANs), local area networks (LANs), wired networks, wireless networks, cable networks, satellite networks, cellular networks, and other suitable networks and combinations thereof. As one example, the computing device 103 and the client device 160 can be communicatively coupled to one or more public or private LANs or WANs and, in turn, to the Internet for communication of data among each other. Although not shown in FIG. 1, the network 150 can also include communicative connections to any number and type of network hosts or devices, such as website servers, file servers, cloud computing resources, databases, data stores, or any other network or computing architectures.

In the networked environment 10, the computing device 103, the client device 160, and other devices can communicate data among each other using any suitable protocols, including one or more network transfer protocols or interconnect frameworks, such as hypertext transfer protocol (HTTP), simple object access protocol (SOAP), representational state transfer (REST), real-time transport protocol (RTP), real time streaming protocol (RTSP), real time messaging protocol (RTMP), user datagram protocol (UDP), internet protocol (IP), transmission control protocol (TCP), other protocols and interconnect frameworks, and combinations thereof.

As illustrated in FIG. 1, the client device 160 includes one or more applications 162 (collectively, “application 162”) executing on the client device 160. As examples, the application 162 can include applications for vehicle speed control, blind spot detection, ADAS, and other applications. The applications can also include hypertext-based network browsers, such as the Internet Explorer®, Firefox®, Chrome®, Safari®, or Silk® browsers, messaging clients, notification clients, data editors or viewers, file browsers, and other applications for other purposes. The client device 160 can interface with the computing device 103 to review and analyze the interference and target data 118 and the interference mitigation output data 121, as well as notifications from ADAS and other systems. The client device 160 can be positioned remotely in some cases to facilitate the review and analysis of the interference and target data 118 and the interference mitigation output data 121.

FIG. 2 illustrates a flowchart illustrating an example method 200 to mitigate interference for automotive radar according to various examples described herein. It is understood that the flowchart of FIG. 2 provides merely an example of the many different types of functional arrangements that may be employed to implement the operation of at least a portion of the interference mitigation system 115 as described herein. As an alternative, the flowchart of FIG. 2 may be viewed as depicting an example of a method implemented in the computing device 103 or the vehicle radar 170 (FIG. 1) according to one or more embodiments. Although the example embodiment described and illustrated in FIG. 2 involves the implementation of the method 200 with automotive radar, the present disclosure is not so limited. For instance, the method 200 can be implemented with various other types of vehicle radar that are used in dynamic applications that require real-time or near real-time signal interference mitigation such as, for example, marine and watercraft radar, aviation and aircraft radar, or another type of radar.

In one example, the method 200 can be implemented in the context of the networked environment 10, which can be embodied and implemented, at least in part, as an interference mitigation system in some cases. For instance, the method 200 can be implemented by the computing device 103 and the radar 170 in the context of the networked environment 10. In this example, the computing device 103 can implement the method 200 using the interference mitigation system 115.

In one example, the computing device 103 (e.g., via the interference mitigation system 115) can implement one or more operations of the method 200 by implementing the methodology described in connection with Equations (1) to (22) and Algorithm 1 included herein. In this example, computer-readable data and computer-executable instructions that can be implemented by any or all of the processor 106, the main processor 107, or the parallel processors 108, independently or in parallel, to perform the methodology described herein in connection with Equations (1) to (22) and Algorithm 1, may be stored in the memory 112. In this example, the computing device 103 (e.g., via the interference mitigation system 115) can utilize any or all of the processor 106, the main processor 107, or the parallel processors 108, independently or in parallel, to perform one or more of the operations of the method 200 described below by implementing corresponding portions of such computer-readable data and computer-executable instructions that, when executed, cause the computing device 103 to perform such operation(s).

Algorithm 1 Soteria

| | |
|---|---|
| 1: | Input: Original signal basis Ψ_{FT} based on (17)-(20), received signal y at current time slot t |
| 2: | Output: Intended signal ŷᵣ |
| 3: | Convert the received signal to baseband through dechirp and LPF (4)-(6) |
| 4: | Transform the baseband signal (9) to frequency-time domain using STFT |
| 5: | Remove the estimated intended signal based on (13)-(15) to get y |
| 6: | Reduce range of signal slope k and delay τ using (21) and (22) |
| 7: | Use CoSaMP to reconstruct the sparse interference signal (16) |
| 8: | Transform the interference signal Ψ_{FT}x back to time domain using inverse STFT |
| 9: | Remove the interference signal from received signal to get the intended signal ŷᵣ = y − |
| | ISTFT{Ψ_{FT}x} |

Beginning with box 206, the method 200 includes the computing device 103 receiving a return signal from the radar 170. The return signal can be generated by the radar 170 and it can include a combination of an intended signal and an interference signal. The intended signal can be generated by the radar 170 upon detecting one or more target objects in a vicinity of a vehicle such as, for instance, an automobile equipped with the radar 170. The interference signal can include one or more interference signals that have been detected by the radar 170 in the vicinity of the automobile. The interference signals detected by the radar 170 can be generated by at least one other radar such as, for example, another automotive radar of another automobile.

In one example, the radar 170 can be embodied and implemented as an automotive radar such as, for instance, a frequency-modulated continuous wave (FMCW) radar. The FMCW radar can include one or more radar sensors positioned at one or more locations in, on, or behind the bumper, the headlight cover, the driver and passenger side mirrors, and at other locations of the automobile. In this example, the computing device 103 (e.g., via the interference mitigation system 115) can define a signal model corresponding to such an FMCW radar system. In this example, the computing device 103 (e.g., via the interference mitigation system 115) can use such a signal model to process the above-described return signal generated by the radar 170 and to perform various interference mitigation operations described herein. The radar 170 can generate the return signal noted above as an FMCW radar signal.

In one particular example, to define the above-described signal model corresponding to the example FMCW radar system of the radar 170 noted above, the computing device 103 (e.g., via the interference mitigation system 115) can implement the methodology described herein in connection with Equations (1) to (3). In this example, by defining a carrier frequency as fc, the computing device 103 (e.g., via the interference mitigation system 115) can define a transmitted signal of an FMCW radar with signal slope kₜ and chirp duration T_{c} in a time domain as:

$${x}_{t} ( t ) = {e}^{j π {k}_{t} {t}^{2}} {e}^{j 2 π {f}_{c} t} , 0 < t < {T}_{c} . \qquad ( 1 )$$

In this example where there are N targets to be detected, the computing device 103 (e.g., via the interference mitigation system 115) can define an intended signal that is to be received at a receiver of the radar 170 as:

$${x}_{r} ( t ) = {\sum }_{n = 1}^{N} {α}_{e}^{n} {e}^{j π {{k}_{t} ( t - {τ}_{e}^{n} )}^{2}} {e}^{j 2 π {f}_{c} ( t - {τ}_{e}^{n} )} , \qquad ( 2 )$$

where n=1, 2, . . . , N is the index of the targets,

$${α}_{e}^{n}$$

represents the path loss between the n-th target to a receiver of the radar 170, and

$${τ}_{e}^{n}$$

is the round-trip delay. In this example, where there are M interfering signals from other radars, the computing device 103 (e.g., via the interference mitigation system 115) can define an interference signal detected at the receiver of the radar 170 as:

$${x}_{i} ( t ) = {\sum }_{m = 1}^{M} {α}_{i}^{m} {e}^{j π {{k}_{i}^{m} ( t - {τ}_{i}^{m} )}^{2}} {e}^{j 2 π {f}_{c} ( t - {τ}_{i}^{m} )} , \qquad ( 3 )$$

where m=1, 2, . . . , M is the index of the interferers,

$${α}_{i}^{m}$$

represents the path loss between the m-th interferer to the receiver, and

$${k}_{i}^{m}$$

is the signal slope of m-th interference component.

At box 209, the method 200 includes transforming the return signal, also referred to as the “received” signal, to baseband. In one example, the computing device 103 (e.g., via the interference mitigation system 115) can convert the return signal to baseband by implementing the methodology described herein in connection with Equations (4) to (9) and Line 3 of Algorithm 1. In this example, the computing device 103 (e.g., via the interference mitigation system 115) can convert both of the above-defined intended signal (2) and interference signal (3) to baseband through dechirp as follows:

$${y}_{r} ( t ) = {x}_{r} ( t ) {{x}_{t} ( t )}^{*} = {\sum }_{n = 1}^{N} {α}_{e}^{n} {e}^{j π {k}_{t} ( {τ}_{e}^{{n}^{2}} - 2 t {τ}_{e}^{n} )} {e}^{- j 2 π {f}_{c} {τ}_{e}^{n}} , \qquad ( 4 )$$

$${y}_{i} ( t ) = {x}_{i} ( t ) {{x}_{t} ( t )}^{*} = {\sum }_{m = 1}^{M} {α}_{i}^{m} {e}^{j π ( ( {k}_{i}^{m} - {k}_{t} ) {t}^{2} - 2 {k}_{i}^{m} t {τ}_{i}^{m} + {k}_{i}^{m} {τ}_{i}^{{m}^{2}} )} {e}^{- j 2 π {f}_{c} {τ}_{i}^{m}} . \qquad ( 5 )$$

After down-conversion, the computing device 103 (e.g., via the interference mitigation system 115) can apply an analog low pass filter (LPF) to remove unwanted frequency components. The computing device 103 (e.g., via the interference mitigation system 115) can define the cut-off frequency of the LPF as f_{L}. After applying the LPF, the computing device 103 (e.g., via the interference mitigation system 115) can preserve all frequency components of the intended signal (4) while bounding the instantaneous frequency of m-th interference component (5) as follows:

$$\vert {f}_{i}^{m} ( t ) \vert = \vert ( {k}_{i}^{m} - {k}_{t} ) t - {k}_{i}^{m} {τ}_{i}^{m} \vert \leq {f}_{L} . \qquad ( 6 )$$

Also, the computing device 103 (e.g., via the interference mitigation system 115) can calculate the interference duration of m-th interference component as follows:

$${T}_{i}^{m} \leq \vert \frac{2 {f}_{L}}{{k}_{i}^{m} - {k}_{t}} \vert . \qquad ( 7 )$$

In this example, after establishing the time and frequency bounds, the computing device 103 (e.g., via the interference mitigation system 115) can express the m-th interference component

$${y}_{i}^{m} ( t )$$

in Equation (5) after applying the LPF as:

$${y}_{i}^{m} ( t ) = {α}_{i}^{m} {e}^{j π ( {k}_{i}^{m} - {k}_{t} ) {t}^{2} - 2 {k}_{i}^{m} t {τ}_{i}^{m} + {k}_{i}^{m} {τ}_{i}^{{m}^{2}} )} {e}^{- j 2 π {f}_{c} {τ}_{i}^{m}} , for max ( 0 , \frac{{k}_{i}^{m} {τ}_{i}^{m} - {f}_{L}}{{k}_{i}^{m} - {k}_{t}} ) < t < min ( \frac{{k}_{i}^{m} {τ}_{i}^{m} + {f}_{L}}{{k}_{i}^{m} - {k}_{t}} , {T}_{c} ) and {y}_{i}^{m} ( t ) = 0 , otherwise . \qquad ( 8 )$$

The computing device 103 (e.g., via the interference mitigation system 115) can express the return (received) signal in baseband as:

$$y ( t ) = {y}_{r} ( t ) + {\sum }_{m = 1}^{M} {y}_{i}^{m} ( t ) , 0 < t < {T}_{c} . \qquad ( 9 )$$

Based on Equation (9), the computing device 103 (e.g., via the interference mitigation system 115) can determine that the interference is time-limited in this example, and thus, the interference power might be much larger than the power of the intended signal in some cases. Therefore, the computing device 103 (e.g., via the interference mitigation system 115) can perform the interference mitigation operations described below with reference to boxes 212 to 227 of the method 200 to eliminate the interference signals in Equation (9).

In box 212, the method 200 includes transforming the baseband form of the return (received) signal as expressed in Equation (9) to the frequency-time domain. In one example, the computing device 103 (e.g., via the interference mitigation system 115) can transform the return (received) signal as expressed in the baseband form of Equation (9) to the frequency-time domain by implementing the methodology described herein in connection with Equations (10) to (12b) and Line 4 of Algorithm 1. In this example, the computing device 103 (e.g., via the interference mitigation system 115) can transform the returned (received) signal expressed in the baseband form of Equation (9) to the frequency-time domain by using a short-time Fourier transform (STFT).

Based on Equation (9), the computing device 103 (e.g., via the interference mitigation system 115) can determine that the return (received) signal in this example is a mix of the intended signal and the interference signal and that such signals are inseparable in the time domain. As such, the computing device 103 (e.g., via the interference mitigation system 115) can thereby determine that other domains are needed to distinguish the difference between the intended signal and the interference signal in this example.

Based on Equation (4), the computing device 103 (e.g., via the interference mitigation system 115) can determine that the phase change of the intended signal from the n-th target in this example is:

$${ϕ}_{e}^{n} ( t ) = π {k}_{t} ( {τ}_{e}^{{n}^{2}} - 2 t {τ}_{e}^{n} ) - 2 π {f}_{c} {τ}_{e}^{n} . \qquad ( 10 )$$

Likewise, from Equation (5), the computing device 103 (e.g., via the interference mitigation system 115) can determine that the phase change of the m-th interference component in this example is:

$${ϕ}_{i}^{m} ( t ) = π ( ( {k}_{i}^{m} - {k}_{t} ) {t}^{2} - 2 {k}_{i}^{m} t {τ}_{i}^{m} + {k}_{i}^{m} {τ}_{i}^{{m}^{2}} - 2 {f}_{c} {τ}_{i}^{m} ) . \qquad ( 11 )$$

Based on Equations (10) and (11), the computing device 103 (e.g., via the interference mitigation system 115) can obtain the instantaneous frequencies of the intended signal (i.e., for the n-th target) and the interference signal (i.e., for the m-th component) in this example as:

$${f}_{e}^{n} ( t ) = \frac{1}{2 π} \frac{d}{dt} {ϕ}_{e}^{n} ( t ) = - {k}_{t} {τ}_{e}^{n} , and \qquad ( 12 a )$$

$${f}_{i}^{m} ( t ) = \frac{1}{2} \frac{d}{dt} {ϕ}_{i}^{m} ( t ) = ( - {k}_{i}^{m} - {k}_{t} ) t - {k}_{i}^{m} {τ}_{i}^{m} . \qquad ( 12 b )$$

Based on Equations (12a) and (12b), the computing device 103 (e.g., via the interference mitigation system 115) can determine that there are two domains that can be explored for signal sparsity in this example: the frequency domain and the frequency-time domain. The computing device 103 (e.g., via the interference mitigation system 115) can determine that, in the frequency domain, the intended signal is a sparse signal with each peak corresponding to one target. On the other hand, the computing device 103 (e.g., via the interference mitigation system 115) can also determine in this example that the power of the time-limited interference signal in Equation (9) will spread over the whole spectrum. For instance, the computing device 103 (e.g., via the interference mitigation system 115) can determine that when the interference level is low, the interference signal in the frequency domain can be considered as noise and the sparse intended signal can be recovered using CS algorithms. The computing device 103 (e.g., via the interference mitigation system 115) can also determine that when the interference power and the number of interferers increase, the interference signal may drown the sparse intended signal and severely degrade the signal reconstruction of the intended signal.

In other aspects, the computing device 103 (e.g., via the interference mitigation system 115) can also determine that, in the frequency-time domain, the interference signal is sparse due to its time-limited nature. Thus, the computing device 103 (e.g., via the interference mitigation system 115) can also determine that in the frequency-time domain, the interference signal can be reconstructed using a CS algorithm. On the other hand, the computing device 103 (e.g., via the interference mitigation system 115) can further determine in this example that the intended signal has constant frequency components with the same spectrum power at all times in most cases, each corresponding to a target object. In this example, the computing device 103 (e.g., via the interference mitigation system 115) can determine that this means the interference signal can be reconstructed in most cases, regardless of interference level. Due to this property, the computing device 103 (e.g., via the interference mitigation system 115) can use a frequency-time domain to analyze and evaluate the sparsity of the interference signal. Accordingly, the computing device 103 (e.g., via the interference mitigation system 115) can transform y in Equation (9) to the frequency-time domain by using short-time Fourier transform (STFT).

Boxes 215-221 relate to generating a reconstructed interference signal. In these boxes, after transforming y to frequency-time domain by using STFT, the method 200 includes the computing device 103 (e.g., via the interference mitigation system 115) reconstructing the interference signal and then removing it from the received signal. Since the intended signal is a constant signal and the interference signal is a sparse signal in the frequency-time domain, the computing device 103 (e.g., via the interference mitigation system 115) can first estimate the constant intended signal and then remove it in this example to improve the interference signal reconstruction accuracy.

In box 215, the intended signal is estimated and removed from the return signal in the frequency-time domain. In one particular example, to estimate and remove the intended signal from the return signal in the frequency-time domain, the computing device 103 (e.g., via the interference mitigation system 115) can implement the methodology described herein in connection with Equations (13) to (16) and Line 5 of Algorithm 1. In this example, the computing device 103 (e.g., via the interference mitigation system 115) can define the received signal in frequency-time domain as |F(l, f)|=STFT {y}, where STFT {⋅} represents the short-time Fourier transform and |F(l, f)| represents the spectrum power of frequency f at sample l. The computing device 103 (e.g., via the interference mitigation system 115) can further define the sample index as l=1, 2, . . . , L in this example, where L is the total number of samples. For the l-th sample, the frequency components can be found by the computing device 103 (e.g., via the interference mitigation system 115) in this example as follows:

$${ℱ}_{l} = P ( \vert F ( l , f ) \vert ) = \{ {f}_{1} , {f}_{2} , …¨ \} , \qquad ( 13 )$$

where [symbol] ₗ is a set of all frequency components at sample I and P (⋅) is the function to find the frequency components with spectrum peaks at sample l. Thus, all the frequency components of the constant intended signal can be estimated by the computing device 103 (e.g., via the interference mitigation system 115) in this example as follows:

$$\{ {f}_{1} , {f}_{2} , … {f}_{N} \} = {ℱ}_{1} ⋂ {ℱ}_{2} ⋂ {ℱ}_{3} , , … , ⋂ {ℱ}_{L} , \qquad ( 14 )$$

where N frequency components correspond to N targets. Then, the power of each frequency component of the intended signal can also be estimated by the computing device 103 (e.g., via the interference mitigation system 115) in this example as follows:

$${p}_{n} = \frac{1}{L} {\sum }_{l = 1}^{L} \vert F ( l , {f}_{n} ) \vert . \qquad ( 15 )$$

After estimating both the frequency components and their spectrum power, the computing device 103 (e.g., via the interference mitigation system 115) can roughly remove the intended signal. The computing device 103 (e.g., via the interference mitigation system 115) can define the residual signal as a sparse interference signal in this example. Thus, the computing device 103 (e.g., via the interference mitigation system 115) can formulate the interference signal reconstruction problem in this example as follows:

$$\begin{matrix}{min}_{x} {‖ x ‖}_{1} \\ s . t . y = {Ψ}_{FT} \cdot x ,\end{matrix} \qquad ( 16 )$$

where ∥⋅∥₁ is the 1-norm, y is the received signal (9) in frequency-time domain after the intended signal is removed by the computing device 103 (e.g., via the interference mitigation system 115), Ψ_{FT} is the signal basis in frequency-time domain including all possible interference signals, and x is the sparse vector (which can be defined by the computing device 103 (e.g., via the interference mitigation system 115) in this example as a projection of the interference signal in the signal basis Ψ_{FT}).

In box 218, the method 200 includes the computing device 103 using a Compressive Sampling Matching Pursuit (CoSaMP) algorithm to reconstruct the sparse interference signal. In one particular example, to reconstruct the sparse interference signal using the CoSaMP algorithm, the computing device 103 (e.g., via the interference mitigation system 115) can implement the methodology described herein in connection with Equations (17) to (20) and Line 7 of Algorithm 1. In this example, the computing device 103 (e.g., via the interference mitigation system 115) can determine that based on Equation (5), there are only two parameters of each interference component in the time domain: signal slope k and delay t. By assuming there are Nₖ available signal slopes, the computing device 103 (e.g., via the interference mitigation system 115) can then determine that the set of slopes, [symbol] ₖ, that the interference signal can take in this example is:

$${𝒮}_{k} = \{ {k}_{1} , … , {k}_{{N}_{k}} \} , \qquad ( 17 )$$

For signal delay τ, it can be discretized by the computing device 103 (e.g., via the interference mitigation system 115) into N_{τ} possible values, with an interval (resolution) of Δ. Then, the computing device 103 (e.g., via the interference mitigation system 115) can determine that the set of delays, [symbol] _{τ}, that the interference signal can take in this example is:

$${𝒟}_{τ} = \{ 0 , Δ , … , {T}_{c} - Δ \} = \{ {τ}_{1} , … , {τ}_{{N}_{τ}} \} , \qquad ( 18 )$$

where

$${N}_{τ} = \frac{{T}_{c}}{Δ}$$

is the total number of hypotheses for τ.

In this example, based on Equations (17) and (18), the computing device 103 (e.g., via the interference mitigation system 115) can form a signal basis for the interference signal in time domain as follows:

$${Ψ}_{T} = [ {I}_{1 , 1} , … , {I}_{{N}_{k} , 1} , {I}_{1 , 2} , … , {I}_{{N}_{k} , 2} , … , {I}_{1 , {N}_{τ}} , … , {I}_{{N}_{k} , {N}_{τ}} ] , \qquad ( 19 )$$

where Iₙ_{ₖ}_{,n}_{_{τ}} is the (Nₖ(n_{τ}−1)+nₖ)-th interference signal in the signal basis Ψ_{T} with slope kₙ_{ₖ} and delay τₙ_{_{τ}}. Iₙ_{ₖ}_{,n}_{_{τ}} being obtained from Equation (8) by the computing device 103 (e.g., via the interference mitigation system 115) by replacing the signal slope

$${k}_{i}^{m}$$

with kₙ_{ₖ} and delay

$${τ}_{i}^{m}$$

with τₙ_{_{τ}} in this example. Thus, the computing device 103 (e.g., via the interference mitigation system 115) can obtain:

$${I}_{{n}_{k} , {n}_{τ}} = {e}^{j π ( ( {k}_{{n}_{k}} - {k}_{t} ) {t}^{2} - 2 {k}_{{n}_{k}} t {τ}_{{n}_{τ}} + {k}_{{n}_{k}} {τ}_{{n}_{τ}}^{2} )} {e}^{- j 2 π {f}_{{c}^{τ} {n}_{τ}}} , \qquad ( 20 )$$

$$max ( 0 , \frac{{k}_{{n}_{k}} {τ}_{{n}_{τ}} - {f}_{L}}{{k}_{{n}_{k}} - {k}_{t}} ) < t < min ( \frac{{k}_{{n}_{k}} {τ}_{{n}_{τ}} + {f}_{L}}{{k}_{{n}_{k}} - {k}_{t}} , {T}_{c} ) and$$

$${I}_{{n}_{k} , {n}_{τ}} = 0 , otherwise ,$$

for nₖ=1, . . . , Nₖ, n_{τ}=1, . . . , N_{τ}. After sampling and transforming all the signals in Ψ_{T} to frequency-time domain, the computing device 103 (e.g., via the interference mitigation system 115) can obtain Ψ_{FT}.

Once y and Ψ_{FT} are obtained, the computing device 103 (e.g., via the interference mitigation system 115) can use a CS algorithm such as, for instance, the CoSaMP algorithm in this example to solve the interference reconstruction problem in Equation (16). It should be appreciated that by using the CoSaMP algorithm to solve Equation (16), the computing device 103 (e.g., via the interference mitigation system 115) can provide advantages not realized by existing interference mitigation technologies. In particular, the CoSaMP algorithm balances the complexity and signal reconstruction performance, and it has a unique structure that can be exploited for parallel computation as described herein in example embodiments. After obtaining the sparse vector x, the computing device 103 (e.g., via the interference mitigation system 115) can reconstruct the interference signal in frequency-time domain in this example as Ψ_{FT}x.

In box 221, the method 200 can include reducing the range of signal slope and delay when implementing the CoSaMP algorithm. In one particular example, to reduce the range of signal slope and delay when using the CoSaMP algorithm, the computing device 103 (e.g., via the interference mitigation system 115) can implement the methodology described herein in connection with Equations (21) to (22) and Line 6 of Algorithm 1. In this example, the computing device 103 (e.g., via the interference mitigation system 115) can determine that the complexity associated with implementing CoSaMP depends on both the maximum number of iterations and the size of the signal basis Ψ_{T}, which is referenced as the search space. Based on Equation (19), the computing device 103 (e.g., via the interference mitigation system 115) can further determine that the size of the search space NₖN_{τ} depends on both the range of signal slope and delay in this example. In this example, the computing device 103 (e.g., via the interference mitigation system 115) can also determine that to ensure accuracy in interference signal reconstruction, the size of the search space should be sufficiently large, which inevitably increases complexity.

Accordingly, the computing device 103 (e.g., via the interference mitigation system 115) can perform the search space reduction operations described in this example to reduce computational time by narrowing down the size of the search space Nₖ and N_{τ} without losing accuracy. In this example, based on Equation (7), since the transmitted signal slope kₜ and the cut-off frequency f_{L} are known, the computing device 103 (e.g., via the interference mitigation system 115) can narrow the range of the signal slope of the interference signal based on an interference duration of the interference signal and data correlation between adjacent time slots. The interference duration can be calculated by the computing device 103 (e.g., via the interference mitigation system 115) based on the signal power in this example. As a result, for the interference signal slope set in Equation (17), the computing device 103 (e.g., via the interference mitigation system 115) can reduce the range to:

$${𝒮}_{k}^{′} = ( {{⋃}_{m = 1}}^{M} [ {k}_{t} - \frac{2 {f}_{L}}{{T}_{i}^{m}} , {k}_{t} + \frac{2 {f}_{L}}{{T}_{i}^{m}} ] ) ⋂ {𝒮}_{k} . \qquad ( 21 )$$

For signal delay, the computing device 103 (e.g., via the interference mitigation system 115) can exploit the correlation of distance estimates between consecutive time slots in this example to reduce the search space. Since the distances between the interferers and the receiver only experience small changes between consecutive time slots in this example, the computing device 103 (e.g., via the interference mitigation system 115) can determine that the interference delay only changes slightly between consecutive time slots. So, in this example the computing device 103 (e.g., via the interference mitigation system 115) can narrow the range of the delay in Equation (18) as follows:

$${𝒟}_{τ}^{′} = ( {{⋃}_{m = 1}}^{M} [ {τ}_{i}^{m} ( t - 1 ) - \frac{2 {VT}_{s}}{c} , {τ}_{i}^{m} ( t - 1 ) + \frac{2 {VT}_{s}}{c} ] ) ⋂ {𝒟}_{τ} , \qquad ( 22 )$$

where

$${τ}_{i}^{m} ( T - 1 )$$

is the delay of the m-th interference signal reconstructed in the last time slot (t−1), V is the maximum speed of the vehicle, Tₛ is the time interval, and c is the speed of light. Regardless of the traveling directions of the interfering radars, the computing device 103 (e.g., via the interference mitigation system 115) can determine the maximum relative speed between the interfering radar and receiver in this example is 2V.

In box 224, the method 200 includes the computing device transforming the reconstructed interference signal to the time domain using an inverse STFT. In one example, to transform the reconstructed interference signal to the time domain using inverse STFT, the computing device 103 (e.g., via the interference mitigation system 115) can implement the methodology described herein in connection with Line 8 of Algorithm 1. In this example, the computing device 103 (e.g., via the interference mitigation system 115) can transform the interference signal Ψ_{FT} x to time domain using inverse STFT.

In box 227, the method 200 includes removing the interference signal from the received signal in the time domain based on the reconstructed interference signal (e.g., based on the time domain version of the reconstructed interference signal). In one example, to remove the interference signal from the received signal in the time domain based on the reconstructed interference signal, the computing device 103 (e.g., via the interference mitigation system 115) can implement the methodology described herein in connection with Line 9 of Algorithm 1. In this example, the computing device 103 (e.g., via the interference mitigation system 115) can remove the interference signal from the received signal in the time domain to obtain the intended signal ŷᵣ=y−ISTFT{Ψ_{FT} x}. Thereafter, the method 200 ends.

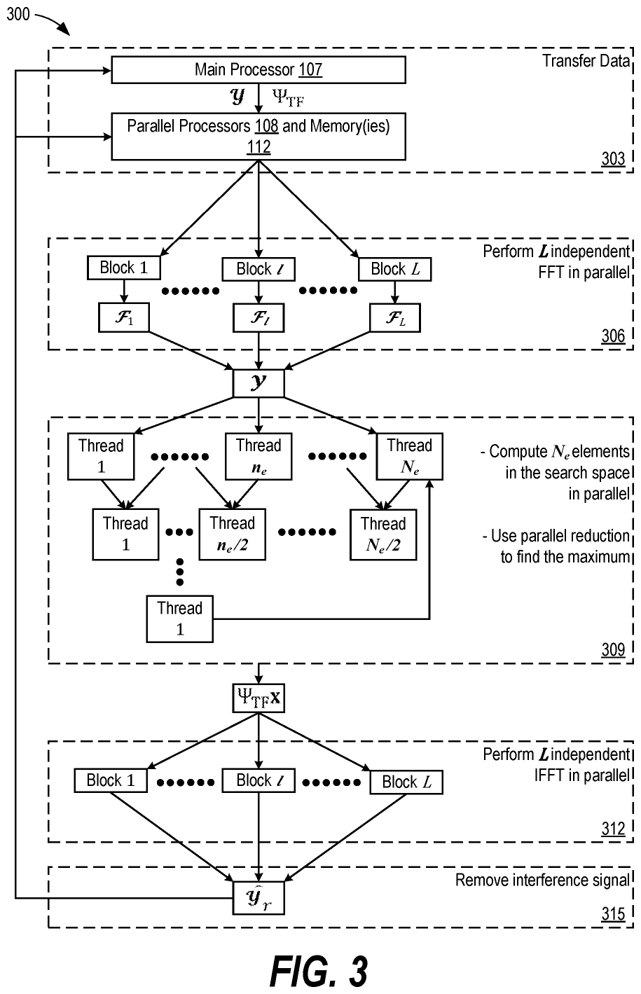

In at least one example, to accelerate computation time, the computing device 103 (e.g., via the interference mitigation system 115) can exploit computational parallelism when performing one or more operations of the method 200 using any or all of methodologies described herein in connection with the Equations (1) to (22) and Algorithm 1. For instance, when implementing the method 200 as described herein, the computing device 103 (e.g., via the interference mitigation system 115) can determine that the most time-consuming steps of the method 200 are steps 212, 218, and 224. The steps 212, 218, and 224 of the method 200 respectively correspond to Lines 4, 7, and 8 of Algorithm 1 in this example, which involve using STFT to transform baseband signal to frequency-time domain (Line 4), using CoSaMP to reconstruct the sparse interference signal (Line 7), and using inverse STFT to transform the reconstructed interference signal to time domain (Line 8). Accordingly, in some cases, the computing device 103 (e.g., via the interference mitigation system 115) can implement method 300 described below and illustrated in FIG. 3 to accelerate the processing speed associated with performing any or all of the aforementioned time-consuming steps of the method 200 and Algorithm 1 by using a GPU.

FIG. 3 illustrates a flowchart illustrating another example method 300 to mitigate interference for automotive radar using a graphics processing unit (GPU) according to various examples described herein. It is understood that the flowchart of FIG. 3 provides merely an example of the many different types of functional arrangements that may be employed to implement the operation of at least a portion of the interference mitigation system 115 as described herein. As an alternative, the flowchart of FIG. 3 may be viewed as depicting an example of elements of a method implemented in the computing device 103 or the vehicle radar 170 (FIG. 1) according to one or more embodiments. Although the example embodiment described and illustrated in FIG. 3 involves the implementation of the method 300 with automotive radar, the present disclosure is not so limited. For instance, the method 300 can be implemented with various other types of vehicle radar that are used in dynamic applications that require real-time or near real-time signal interference mitigation such as, for example, marine and watercraft radar, aviation and aircraft radar, or another type of radar.

In one example, the method 300 can be implemented in the context of the networked environment 10, which can be embodied and implemented, at least in part, as an interference mitigation system in some cases. For instance, the method 300 can be implemented by the computing device 103 and the radar 170 in the context of the networked environment 10. In this example, the computing device 103 can implement the method 300 using the interference mitigation system 115. A particular advantage of the method 300 is that it can be implemented to perform certain radar interference mitigation operations described herein in real-time by leveraging parallel computation of a GPU.

In one example, the computing device 103 (e.g., via the interference mitigation system 115) can implement one or more operations of the method 300 by implementing the methodology described herein in connection with Equations (1) to (22) and Algorithm 1. In this example, computer-readable data and computer-executable instructions that can be implemented by any or all of the processor 106, the main processor 107, or the parallel processors 108, independently or in parallel, to perform the methodology described herein in connection with Equations (1) to (22) and Algorithm 1, may be stored in the memory 112. In this example, the computing device 103 (e.g., via the interference mitigation system 115) can utilize any or all of the processor 106, the main processor 107, or the parallel processors 108, independently or in parallel, to perform one or more of the operations of the method 300 described below by implementing corresponding portions of such computer-readable data and computer-executable instructions that, when executed, cause the computing device 103 to perform such operation(s).

As noted above, in some cases, the computing device 103 (e.g., via the interference mitigation system 115) can implement method 300 to accelerate the processing speed associated with performing any or all of the aforementioned time-consuming steps 212, 218, and 224 of the method 200 and Lines 4, 7, and 8 of Algorithm 1 by using a GPU. In one example, the computing device 103 (e.g., via the interference mitigation system 115) can employ the parallel processors 108 to implement method 300. In this example, the parallel processors 108 are embodied and implemented, at least in part, as a GPU.

Beginning with box 303, the method 300 includes transferring the baseband signal of Equation (9) and the original signal basis Ψ_{FT} from a host to a GPU global memory. For instance, the computing device 103 (e.g., via the interference mitigation system 115) can transfer the baseband signal of Equation (9) and the original signal basis Ψ_{FT} from the main processor 107 to the parallel processors 108 and the memory 112. In this example, the main processor 107 can be embodied and implemented, at least in part, as a CPU and the memory 112 can be embodied and implemented, at least in part, as a GPU global memory.

In box 306, the method 300 includes implementing Line 4 in Algorithm 1, which involves performing L independent Fast Fourier Transforms (FFT) in parallel. In the example depicted in FIG. 3, at box 306, the computing device 103 (e.g., via the interference mitigation system 115) can employ the parallel processors 108 to implement Line 4 in Algorithm 1 and perform the above-described operations in box 212 of the method 200. In this example, the parallel processors 108 are embodied and implemented as N_{SM} Streaming Multiprocessors (SMs). In this example, each of such N_{SM} SMs schedules a number of warps, a warp being a group of 32 threads. So, in this example the computing device 103 (e.g., via the interference mitigation system 115) can cause the parallel processors 108 to generate a kernel with/blocks as illustrated in FIG. 3. Each block in this example includes

$$\frac{{N}_{SM} \times 32}{L}$$

threads to feed the parallel processors 108. Each block in this example computes one FFT by using a FFT library (e.g., cuFFT library). After FFT, in the l-th block, the spectrum peaks can be found by the computing device 103 (e.g., via the interference mitigation system 115 and/or the parallel processors 108) based on |F(l, f)| in this example. Finally, by collecting all spectrum peaks from all blocks, the computing device 103 (e.g., via the interference mitigation system 115 and/or the parallel processors 108) can estimate and remove the intended signal.

In box 309, the method 300 includes implementing Line 7 in Algorithm 1, which involves computing Nₑ elements in the search space in parallel and using parallel reduction to find the maximum. In the example depicted in FIG. 3, at box 309, the computing device 103 (e.g., via the interference mitigation system 115) can employ the parallel processors 108 to implement Line 7 in Algorithm 1 and perform the above-described operations in box 218 of the method 200. In this example, in each iteration of the CoSaMP algorithm, the interference component corresponding to the largest correlation factor is chosen by the computing device 103 (e.g., via the interference mitigation system 115) as one interference component. In this example, the computing device 103 (e.g., via the interference mitigation system 115) can cause the parallel processors 108 to generate a kernel with Nₑ threads as illustrated in FIG. 3, where Nₑ is the size of the reduced search space. In the i-th iteration of the CoSaMP algorithm, (Nₑ−i+1) threads are allocated in this example by the computing device 103 (e.g., via the interference mitigation system 115 and/or the parallel processors 108) to compute the correlation factor of all elements in the search space. Next,

$$⌈ \frac{{N}_{e} - i + 1}{2} ⌉$$

threads are used by the computing device 103 (e.g., via the interference mitigation system 115 and/or the parallel processors 108) to perform parallel reduction to find the interference component in this iteration of this example. During parallel reduction, an on-chip shared memory of the computing device 103 and/or the memory 112 can be used in this example instead of a GPU global memory (i.e., the memory 112 in this example) to accelerate the computational time. After the last iteration in this example, the computing device 103 (e.g., via the interference mitigation system 115) can obtain the reconstructed interference signal in the frequency-time domain.

In box 312, the method 300 includes implementing Line 8 in Algorithm 1, which involves performing L independent Inverse Fast Fourier Transforms (IFFT) in parallel. In the example depicted in FIG. 3, at box 312, the computing device 103 (e.g., via the interference mitigation system 115) can employ the parallel processors 108 to implement Line 8 in Algorithm 1 and perform the above-described operations in box 224 of the method 200. In this example, the computing device 103 (e.g., via the interference mitigation system 115 and/or the parallel processors 108) can allocate L blocks to perform STFT in parallel as illustrated in FIG. 3. In this example, the computing device 103 (e.g., via the interference mitigation system 115) can use the parallel processors 108 to perform STFT in parallel in the same or similar manner as described above in box 306.

In box 315, the method 300 includes removing the interference signal from the received signal and transferring the intended signal to the main processor 107. For instance, in box 315, the computing device 103 (e.g., via the interference mitigation system 115) can remove the interference signal from the received signal in the same manner as described above in box 227 of the method 200. Thereafter, the computing device 103 (e.g., via the interference mitigation system 115) can transfer the intended signal to the main processor 107.

Referring now to FIG. 1, in some cases, there may be other executable-code components such as other applications that are stored in the memory 112 and are executable by the processor 106 as can be appreciated. For example, an operating system can be stored in the memory 112 for execution by the processor 106. Where any component discussed herein is implemented in the form of software, any one of a number of programming languages may be employed such as, for example, CUDA, C, C++, C#, Objective C, Java®, JavaScript®, Perl, PHP, Visual Basic®, Python®, Ruby, Flash®, or other programming languages.

A number of software components are stored in the memory 112 and are executable by the processor 106. In this respect, the term “executable” means a program file that is in a form that can ultimately be run by the processor 106. Examples of executable programs may be, for example, a compiled program that can be translated into machine code in a format that can be loaded into a random access portion of the memory 112 and run by the processor 106, source code that may be expressed in proper format such as object code that is capable of being loaded into a random access portion of the memory 112 and executed by the processor 106, or source code that may be interpreted by another executable program to generate instructions in a random access portion of the memory 112 to be executed by the processor 106, etc. An executable program may be stored in any portion or component of the memory 112 including, for example, random access memory (RAM), read-only memory (ROM), hard drive, solid-state drive, or other memory components.

The memory 112 is defined herein as including both volatile and nonvolatile memory and data storage components. Volatile components are those that do not retain data values upon loss of power. Nonvolatile components are those that retain data upon a loss of power. Thus, the memory 112 may comprise, for example, random access memory (RAM), read-only memory (ROM), hard disk drives, solid-state drives, and/or other memory components, or a combination of any two or more of these memory components. In addition, the RAM may comprise, for example, static random-access memory (SRAM), dynamic random-access memory (DRAM), or magnetic random-access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 106 may represent multiple processors 106 and/or multiple processor cores and the memory 112 may represent multiple memories 112 that operate in parallel processing circuits, respectively. In such a case, the local interface 109 may be an appropriate network that facilitates communication between any two of the multiple processors 106, between any processor 106 and any of the memories 112, or between any two of the memories 112, etc.

The flowcharts of FIGS. 2 and 3 each show the functionality and operation of an implementation of portions of the interference mitigation system 115. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as the processor 106 in a computer system or other system. The machine code may be converted from the source code, etc. If embodied in hardware, each block may represent a circuit or a number of interconnected circuits to implement the specified logical function(s).

Although the flowcharts of FIGS. 2 and 3 each show a specific order of execution, it is understood that the order of execution may differ from that which is depicted. For example, the order of execution of two or more blocks may be scrambled relative to the order shown. Also, two or more blocks shown in succession in either or both of FIGS. 2 and 3 may be executed concurrently or with partial concurrence. Further, in some embodiments, one or more of the blocks shown in either or both of FIGS. 2 and 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the interference mitigation system 115 that comprises software or code can be embodied in any non-transitory computer-readable medium for use by or in connection with an instruction execution system such as, for example, the processor 106 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. In the context of the present disclosure, a “non-transitory computer-readable medium” can be any tangible medium that can contain, store, or maintain any logic, application, software, or executable-code component described herein for use by or in connection with an instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random-access memory (RAM) including, for example, static random-access memory (SRAM) and dynamic random-access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the interference mitigation system 115, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing devices 103, in the radar 170, or in multiple computing devices. Additionally, it is understood that terms such as “application,” “service,” “system,” “engine,” “module,” and so on may be interchangeable and are not intended to be limiting.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present. As referenced herein in the context of quantity, the terms “a” or “an” are intended to mean “at least one” and are not intended to imply “one and only one.”

As referred to herein, the terms “includes” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A method to mitigate interference for a vehicle radar, comprising:
receiving a return signal comprising a combination of an intended signal and an interference signal using the vehicle radar;
transforming the return signal to a frequency-time domain return signal using a short-time Fourier transform;
determining a reconstructed interference signal in the frequency-time domain based on the frequency-time domain return signal, the reconstructed interference signal comprising an estimation of the interference signal;
transforming the reconstructed interference signal to a time domain version of the reconstructed interference signal; and
removing the interference signal in the time domain from the return signal to isolate the intended signal in the time domain based on the time domain version of the reconstructed interference signal.

2. The method of claim 1, wherein the interference signal originates from one or more other vehicle radars.

3. The method of claim 1, wherein determining the reconstructed interference signal in the frequency-time domain comprises:
determining an estimated intended signal in the frequency-time domain, comprising:
estimating one or more frequency components of a sample index of the frequency-time domain return signal; and
estimating a spectrum power of the one or more frequency components; and
removing the estimated intended signal in the frequency-time domain from the frequency-time domain return signal.

4. The method of claim 3, wherein determining the reconstructed interference signal in the frequency-time domain further comprises using a compressive sampling matching pursuit (CoSaMP) algorithm.

5. The method of claim 4, wherein using the CoSaMP algorithm comprises determining a size of a signal basis of the interference signal in the time domain, the signal basis corresponding to a search space containing all possible interference signals and the interference signal.

6. The method of claim 5, wherein using the CoSaMP algorithm further comprises reducing the size of the signal basis by reducing a range of a signal slope and a delay of the interference signal in the time domain.

7. The method of claim 6, wherein reducing the range of the signal slope and the delay of the interference signal is based on an interference duration of the interference signal and data correlation between adjacent time slots.

8. The method of claim 6, wherein the CoSaMP algorithm is implemented in a graphics processing unit (GPU) comprising a plurality of streaming multiprocessors (SMs), the GPU generating a kernel with a number of threads, the number of threads corresponding to the size of a reduced signal basis.

9. The method of claim 8, wherein the GPU is configured to use parallel reduction in implementing the CoSaMP algorithm to determine the reconstructed interference signal based on the number of threads.

10. The method of claim 1, wherein transforming the reconstructed interference signal to the time domain version of the reconstructed interference signal comprises using an inverse short-time Fourier transform (ISTFT).

11. The method of claim 10, wherein the ISTFT is implemented in a graphics processing unit (GPU) comprising a plurality of streaming multiprocessors (SMs), the GPU generating a plurality of blocks, each block being configured to compute the ISTFT in parallel.

12. The method of claim 1, wherein transforming the return signal to the frequency-time domain return signal is implemented in a graphics processing unit (GPU) comprising a plurality of streaming multiprocessors (SMs), each SM scheduling a number of warps, wherein a warp is a group of threads.

13. The method of claim 12, wherein the GPU generates a kernel with a plurality of blocks, each block being configured to compute the short-time Fourier transform in parallel.

14. A computing device, comprising:
a memory to store computer-readable instructions thereon; and
at least one processor configured through execution of the computer-readable instructions to:
receive a return signal using a vehicle radar, the return signal comprising an intended signal and an interference signal;
transform the return signal to a frequency-time domain return signal using a short-time Fourier transform;
determine a reconstructed interference signal in the frequency-time domain based on the frequency-time domain return signal, the reconstructed interference signal comprising an estimation of the interference signal;
transform the reconstructed interference signal to a time domain version of the reconstructed interference signal; and
remove the interference signal in the time domain from the return signal to isolate the intended signal in the time domain based on the time domain version of the reconstructed interference signal.

15. The computing device of claim 14, wherein, to determine the reconstructed interference signal in the frequency-time domain, the at least one processor is further configured to:
determine an estimated intended signal in the frequency-time domain; and
remove the estimated intended signal in the frequency-time domain from the frequency-time domain return signal.

16. The computing device of claim 15, wherein, to determine the reconstructed interference signal in the frequency-time domain, the at least one processor is further configured to:
use a compressive sampling matching pursuit (CoSaMP) algorithm to determine the reconstructed interference signal in the frequency-time domain.

17. The computing device of claim 16, wherein, to use the CoSaMP algorithm to determine the reconstructed interference signal in the frequency-time domain, the at least one processor is further configured to:
determine a size of a signal basis of the interference signal in the time domain, the signal basis corresponding to a search space containing all possible interference signals and the interference signal.

18. The computing device of claim 17, wherein, to use the CoSaMP algorithm to determine the reconstructed interference signal in the frequency-time domain, the at least one processor is further configured to:
reduce the size of the signal basis by reducing a range of a signal slope and a delay of the interference signal in the time domain.

19. The computing device of claim 18, wherein, to reduce the range of the signal slope and the delay of the interference signal in the time domain, the at least one processor is further configured to:
reduce the range of the signal slope and the delay of the interference signal in the time domain based on an interference duration of the interference signal and data correlation between adjacent time slots.

20. A system, comprising:
a vehicle radar coupled to a computing device,
wherein the computing device is configured to:
receive a return signal using the vehicle radar, the return signal comprising an intended signal and an interference signal;
transform the return signal to a frequency-time domain return signal using a short-time Fourier transform;
determine a reconstructed interference signal in the frequency-time domain based on the frequency-time domain return signal, the reconstructed interference signal comprising an estimation of the interference signal;
transform the reconstructed interference signal to a time domain version of the reconstructed interference signal; and
remove the interference signal in the time domain from the return signal to isolate the intended signal in the time domain based on the time domain version of the reconstructed interference signal.
